(19) United States
(12) Patent Application Publication
(10) Pub. No.: US 2020/0410974 A1
(43) Pub. Date: Dec. 31, 2020

(54) CAR CHARGING DEVICE WITH NOISE REDUCTION FUNCTION

(71) Applicant: LUXSHARE PRECISION INDUSTRY Co., Ltd., Shenzhen (CN)

(72) Inventors: Yun Feng, Shenzhen (CN); Min Fan, Shenzhen (CN); Rong-Qin Lan, Shenzhen (CN); Peng Liao, Shenzhen (CN)

(73) Assignee: LUXSHARE PRECISION INDUSTRY Co., Ltd., Shenzhen (CN)

(21) Appl. No.: 17/015,528

(22) Filed: Sep. 9, 2020

(30) Foreign Application Priority Data
Apr. 24, 2020 (CN) 202020645458.3

(51) Int. Cl. G10K 11/178; H02J 7/00

(52) U.S. Cl. CPC G10K 11/17823; G10K 11/17873; H02J 7/0045; G10K 2210/1053; H02J 2207/20; G10K 2210/1082; G10K 2210/12821

(57) ABSTRACT

A car charging device includes a main body, a charging interface, an input terminal, a conversion circuit, a microphone, a loudspeaker, and a noise reduction circuit. A main body includes an insertion portion and the top. The charging interface includes a charging terminal. The input terminal is located at the insertion portion. The conversion circuit is electrically connected to the input terminal and the charging terminal and configured to convert electric power. The microphone is located on the top and configured to convert a sound into an input audio. The loudspeaker is located on the top. The noise reduction circuit is configured to generate a noise reduction audio according to the input audio, and drive, by using the noise reduction audio, the loudspeaker to emit a noise reduction sound, where the noise reduction audio is an inversion of a regular audio continuing for a preset time in the input audio.

### CROSS-REFERENCE TO RELATED APPLICATION

This non-provisional application claims priority under 35 U.S.C. § 119(a) to Patent Application No. 202020645458.3 filed in China, P.R.C. on Apr. 24, 2020, the entire contents of which are hereby incorporated by reference.

### BACKGROUND

### Technical Field

The present invention relates to a car charger, and in particular, to a car charger having a loudspeaker and a microphone.

### Related Art

Most of general car chargers provide low-voltage power supply output, so as to provide electric power to a connected electronic component. However, in conventional technologies, noise reduction in a vehicle usually depends on existing pre-installed components of the vehicle. For example, noise reduction in the vehicle is performed by built-in electronic control system and loudspeaker of the vehicle.

### SUMMARY

In view of this, according to some embodiments, the present invention provides a car charging device with a noise reduction function. The car charging device can achieve a function of active noise reduction without using a pre-installed electronic control system or loudspeaker of a vehicle. The car charging device with a noise reduction function includes a main body, a charging interface, an input terminal, a conversion circuit, a microphone, a loudspeaker, and a noise reduction circuit. A main body comprises an insertion portion and the top. The charging interface comprises a charging terminal and is located on the top. The input terminal is located at the insertion portion. The conversion circuit is electrically connected to the input terminal and the charging terminal, where the conversion circuit is configured to convert electric power from the input terminal and output the electric power through the charging terminal. The microphone is located by the side of the charging interface and configured to convert a sound into an input audio. The loudspeaker is located on the top. The noise reduction circuit is configured to generate a noise reduction audio according to the input audio, and drives, by using the noise reduction audio, the loudspeaker to emit a noise reduction sound, where the noise reduction audio is an inversion of a regular audio continuing for a preset time in the input audio.

According to some embodiments, the main body has an insert axis, the loudspeaker has a sound emitting direction, and an angle between the sound emitting direction and the insert axis is between 15 degrees and 75 degrees.

According to some embodiments, when the noise reduction audio is less than a preset value, the noise reduction circuit does not drive the loudspeaker to generate the noise reduction sound.

According to some embodiments, the microphone has a sound receiving direction, and the sound receiving direction is opposite to the sound emitting direction of the loudspeaker.

According to some embodiments, the main body further includes a surface cover, and the surface cover is located on the top and covers the loudspeaker.

According to some embodiments, the main body further includes a main housing and a shell, where the main housing is located at the insertion portion, the shell is located on the top, one side of the shell is connected to the surface cover and another side is connected to the main housing, the input terminal being disposed on the main housing, and the charging terminal being disposed on the shell.

According to some embodiments, the charging terminal is a USB interface.

According to some embodiments, the conversion circuit further has a luminescent module, a light guide module, and a drive circuit, where the drive circuit is electrically connected to the conversion circuit and the luminescent module, and the luminescent module is adjacent to the light guide module; the light guide module has an exposed portion, and the exposed portion is exposed to the top; and when the conversion circuit receives the electric power, the drive circuit drives the luminescent module to emit light, and the light guide module guides the light to the exposed portion.

The following describes the specific features and advantages of the present invention in detail in implementations, the content of which is enough to enable any person skilled in the related art to understand and implement the technical content in the present invention. According to the content disclosed in the specification, the claims, and the drawings, any person skilled in the related art can easily understand the related objective and advantages of the present invention.

### BRIEF DESCRIPTION OF THE DRAWINGS

FIG. 1 is a three-dimensional schematic diagram 1 of a car charging device with a noise reduction function according to some embodiments;

FIG. 2 is a three-dimensional schematic diagram 2 of a car charging device with a noise reduction function according to some embodiments;

FIG. 3 is a block diagram of a structure of a car charging device with a noise reduction function according to some embodiments;

FIG. 4 is a schematic diagram of positions of a microphone and a loudspeaker according to some embodiments;

FIG. 5 is a schematic diagram of usage of a car charging device with a noise reduction function according to some embodiments; and

FIG. 6 is a partial schematic diagram of a car charging device with a noise reduction function according to some embodiments.

### DETAILED DESCRIPTION

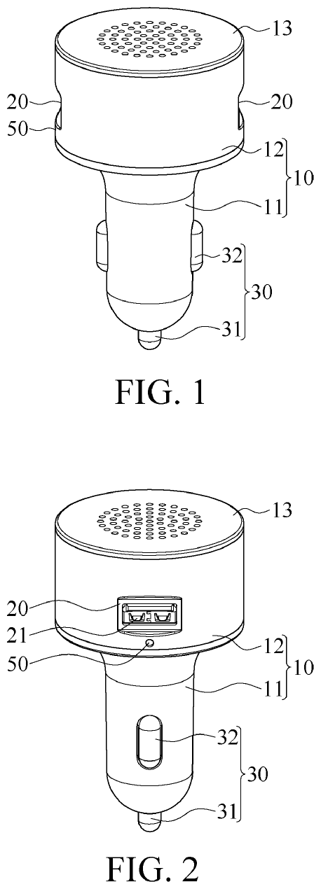

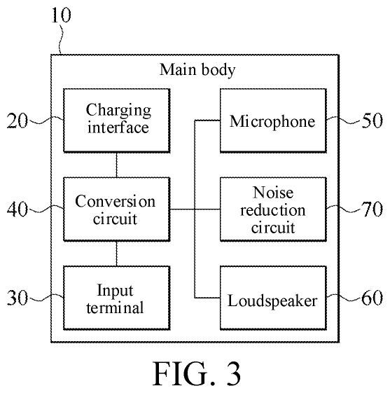

Referring to FIG. 1, FIG. 2, and FIG. 3, FIG. 1 is a three-dimensional schematic diagram 1 of a car charging device with a noise reduction function according to some embodiments. FIG. 2 is a three-dimensional schematic diagram 2 of a car charging device with a noise reduction function according to some embodiments. FIG. 3 is a block diagram of a structure of a car charging device with a noise reduction function according to some embodiments.

In this embodiment, the car charging device with a noise reduction function (referred to as a car charging device in the following) includes a main body 10, a charging interface 20, an input terminal 30, a conversion circuit 40, a microphone 50, a loudspeaker 60, and a noise reduction circuit 70.

The main body 10 has an insertion portion 11 and a top 12. The insertion portion 11 may have a corresponding geometrical shape fitting a slot structure of an automotive charging socket. For example, the insertion portion 11 may be, but is not limited to, the cylindrical object shown in FIG. 1. The top 12 has a side surface. The car charging device is inserted into a slot of the automotive charging socket (such as a car cigarette lighter socket) through the insertion portion 11, so that an electrical connection point of the insertion portion 11 is connected to an electrical connection point inside the slot of the automotive charging socket. Therefore, the car charging device is electrically connected to a power supply system on a vehicle.

The charging interface 20 has a charging terminal 21 and is located on the side surface of the top 12, but it is not limited thereto. In another embodiment, the charging interface 20 may alternatively be located on a top surface of the top 12. In some embodiments, an electrical connection end of an external electronic device to be charged may be connected to the charging interface 20 and electrically connected to the charging terminal 21 inside the charging interface 20.

The input terminal 30 is located at the insertion portion 11, and the input terminal 30 may be a metal conductor piece. In some embodiments, the input terminal 30 includes a positive elastic contact cap 31 located on a tail end of the insertion portion 11 and a negative elastic contact plate 32 located on two sides of the insertion portion 11.

The conversion circuit 40 is electrically connected to the input terminal 30 and the charging terminal 21, where the conversion circuit 40 can be implemented by, for example, but not limited to, a printed circuit board. In this embodiment, the input terminal 30 at the insertion portion 11 is electrically connected to a positive electrode and a negative electrode of the power supply system on the vehicle, so as to input electric power to the conversion circuit 40. Subsequently, the conversion circuit 40 receives the electric power from the input terminal 30 and converts the electric power into electric power having a proper voltage, and then outputs the electric power through the charging terminal 21.

The microphone 50 is located by the side of the charging interface 20, but is not limited thereto. In another embodiment, the microphone 50 may alternatively be located on the top surface or another position of the side surface of the top 12. In another embodiment, the microphone 50 is a separable component, and may be placed at a specific position inside the vehicle and connected to the conversion circuit 40 and the noise reduction circuit 70 in a wired or wireless way. In this embodiment, the microphone 50 is electrically connected to the conversion circuit 40 and the noise reduction circuit 70. After the conversion circuit 40 receives the electric power from the input terminal 30 and converts the electric power into the electric power having the proper voltage, the microphone 50 is driven to act, so as to collect a sound and convert the sound into an input audio. In this embodiment, the microphone 50 is located below the charging interface 20. In some embodiments, the microphone 50 may be disposed above the charging interface 20, or on a left side or a right side of the charging interface 20. In some embodiments, a sound collected by the microphone 50 includes, but is not limited to wind noise, tire noise, a rain sound, and an engine sound.

The loudspeaker 60 is located on the top 12, and is electrically connected to the conversion circuit 40 and the noise reduction circuit 70. After the conversion circuit 40 receives the electric power from the input terminal 30 and converts the electric power into the electric power having the proper voltage, the loudspeaker 60 is driven to act. In another embodiment, the loudspeaker 60 is a separable component, and may be placed at a specific position inside the vehicle and connected to the conversion circuit 40 in a wired or wireless way.

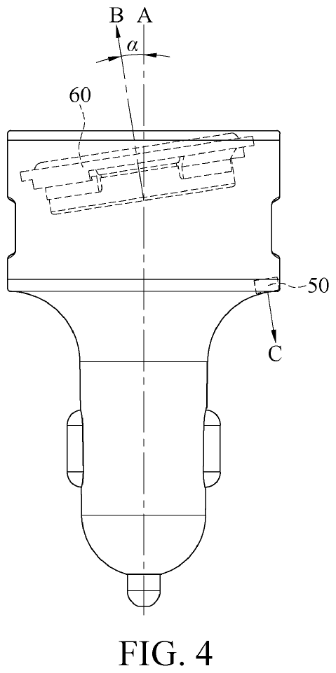

Referring to FIG. 4, FIG. 4 is a schematic diagram of positions of a microphone and a loudspeaker according to some embodiments. In some embodiments, the main body 10 has an insert axis A, the loudspeaker 60 has a sound emitting direction B, and there is an angle α between the sound emitting direction B and the insert axis A. Further, an angle of the loudspeaker 60 may be adjusted. In some embodiments, the angle α is between 15 degrees and 75 degrees. In some embodiments, the microphone 50 has a sound receiving direction C, and the sound receiving direction C is opposite to the sound emitting direction B. That is, a direction that the microphone 50 faces is opposite to a direction that the loudspeaker 60 faces. In this way, when noise is transmitted from a lower right corner of FIG. 4 to an upper left corner (corner a) of FIG. 4, the car charging device may generate a noise reduction sound Vd, so as to eliminate the noise (described in detail in the following).

The noise reduction circuit 70 may be electrically connected to the conversion circuit 40, the microphone 50, and the loudspeaker 60 separately. After the conversion circuit 40 receives the electric power from the input terminal 30 and converts the electric power into the electric power having the proper voltage, the noise reduction circuit 70 is driven to act, so that the noise reduction circuit 70 generates a noise reduction audio according to an input audio converted by the microphone 50, and then drives, by using the noise reduction audio, the loudspeaker 60 to emit a noise reduction sound.

In some embodiments, the noise reduction audio is an inversion of a regular audio continuing for a preset time in the input audio. For example, the vehicle travels stably for 0 s to 10 s, and the microphone 50 stably collects tire noise for 0 s to 10 s. Because the tire noise is collected in a continuous and stable way, when the tire noise is converted into the input audio, the tire noise becomes the regular audio. The noise reduction circuit 70 continues to use the noise reduction audio to drive the loudspeaker 60 to emit the noise reduction sound (the inversion of the regular audio) within a preset time of 0 s to 10 s.

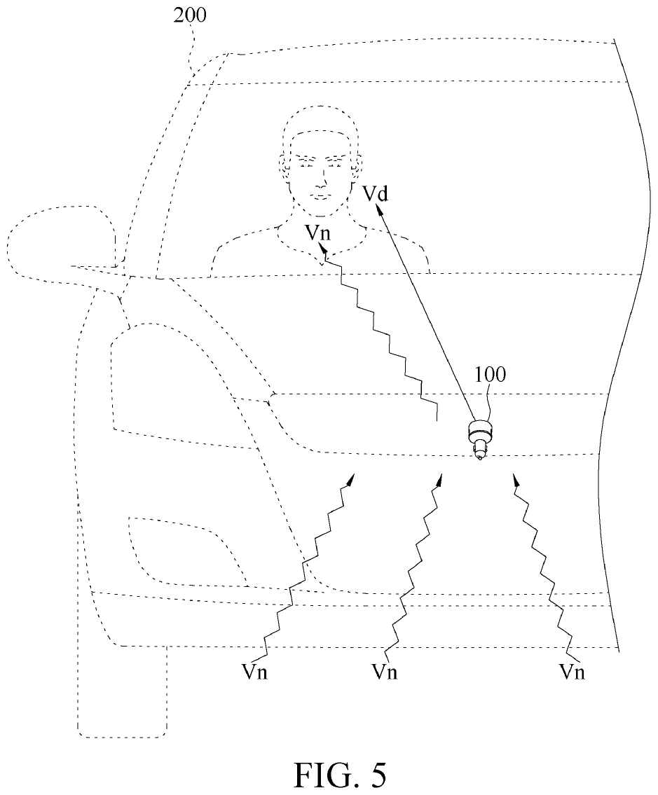

Referring to FIG. 5, FIG. 5 is a schematic diagram of a car charging device with a noise reduction function according to some embodiments. In some embodiments, a car charging device 100 is disposed in the middle of a vehicle 200. Based on this, the car charging device 100 is capable of collecting a tire noise Vn coming from the bottom of the vehicle 200. Subsequently, the loudspeaker 60 further emits the noise reduction sound Vd to counteract the tire noise Vn. For example, the vehicle 200 travels stably for 10 minutes, and after the car charging device 100 receives the tire noise Vn, the noise reduction sound Vd is sent to counteract the tire noise Vn. In this embodiment, a sound receiving direction of the microphone 50 is towards the bottom of the vehicle 200. In another embodiment, the sound receiving direction of the microphone 50 may also be towards a window or an engine room of the vehicle 200.

In some embodiments, the noise reduction circuit 70 is configured to generate a noise value according to the input audio converted by the microphone 50, and the noise reduction circuit 70 compares the noise value with a preset value. If the noise value is greater than the preset value, the noise reduction circuit 70 generates the noise reduction audio, and drives, by using the noise reduction audio, the loudspeaker 60 to emit a noise reduction sound; if the noise value is less than the specified preset value, the noise reduction circuit 70 does not generate or no longer generates the foregoing noise reduction audio, that is, the noise reduction circuit 70 does not drive or no longer drives the loudspeaker 60 to emit the noise reduction sound. This represents that when a sound collected by the microphone 50 does not produce perceivable noise actually, the loudspeaker 60 no longer emits the noise reduction sound.

In some embodiments, when the noise reduction circuit 70 produces the noise reduction audio, and drives, by using the noise reduction audio, the loudspeaker 60 to emit the noise reduction sound, the noise reduction sound counteracts noise in the vehicle. In this case, the microphone 50 collects sound continuously, and the noise reduction circuit 70 continuously generates a new noise value according to the input audio converted by the microphone 50. However, because the noise in the vehicle has been counteracted by the noise reduction sound sent by the loudspeaker 60, without other new noise, the noise value generated by the noise reduction circuit 70 should be less than the preset value, and in this case, the noise reduction circuit 70 continues to emit a previous unadjusted noise reduction audio, so as to drive the loudspeaker 60 to emit a previous unadjusted noise reduction sound. When new external noise with volume high enough is generated, the noise value generated by the noise reduction circuit 70 according to a later input audio (after the new external noise is generated) converted by the microphone 50 is equal to or greater than the preset value. In this case, the noise reduction circuit 70 generates an adjusted noise reduction audio according to the later input audio, and uses the adjusted noise reduction audio to drive the loudspeaker 60 to emit an adjusted noise reduction sound. In this way, the car charging device 100 can perform active noise reduction in a continuous and dynamic way, that is, after the car charging device 100 emits an initial noise reduction audio and performs the active noise reduction by using the loudspeaker 60, the car charging device 100 can still continuously obtain a feedback through the input audio from the microphone 50, thereby determining whether to maintain or adjust the noise reduction audio.

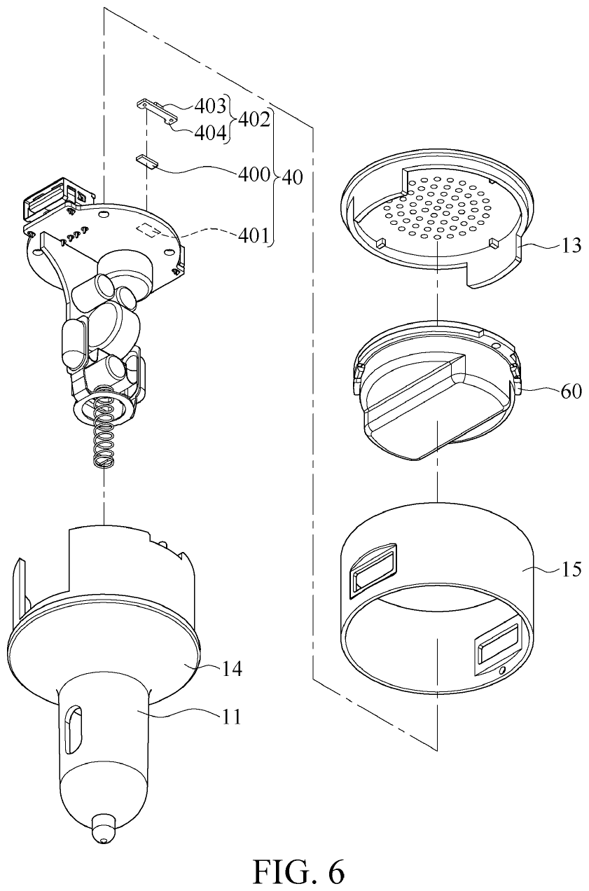

Referring to FIG. 6, FIG. 6 is a partial schematic diagram of a car charging device with a noise reduction function according to some embodiments. In some embodiments, the main body 10 further includes a surface cover 13. The surface cover 13 may be, but is not limited to a flat board body structure. The surface cover 13 is located on the top 12 and covers the loudspeaker 60. Therefore, when the car charging device is inserted into a slot of an automotive charging socket, the surface cover 13 is exposed to the automotive charging socket, and a plurality of dense holes are distributed on the surface of the surface cover 13, so that a noise reduction sound from the loudspeaker 60 can be transmitted through the dense holes.

In some embodiments, the main body 10 further includes a main housing 14 and a shell 15. The main housing 14 is located at the insertion portion 11. The shell 15 is located on the top 12 and below the surface cover 13, and one side of the shell 15 is connected to the surface cover 13 and another side is connected to the main housing 14. In other words, the surface cover 13, the shell 15, and the main housing 14 are connected in sequence to form the main body 10. The input terminal 30 is disposed on the main housing 14.

In some embodiments, the specification of the charging interface 20 may be a USB output interface, such as but not limited to: type C, type A, and Micro-B interface specification. In some embodiments, at least one charging interface 20 is located on the shell 15. In this embodiment, the charging interfaces 20 are located on two opposite sides of the shell 15 respectively.

In some embodiments, the conversion circuit 40 further includes a light emitting component 400, a light guiding component 402, and a drive circuit 401. The drive circuit 401 is electrically connected to the light emitting component 400, and the light emitting component 400 is adjacent to the light guiding component 402. The light guiding component 402 has an exposed portion 403 and a light guiding body 404. The exposed portion 403 is located on the light guiding body 404 and exposed to the top 12. For example, the light emitting component 400 may be, but is not limited to a light-emitting diode module. The light guiding component 402 may be a light guiding plate or a light guiding bar, and may be made of but not limited to: acrylic, resin, plastic and other translucent materials.

The car charging device is provided with a microphone, a loudspeaker, and a noise reduction circuit, to resolve the conventional problem that a vehicle active noise reduction system depends on components pre-installed on the vehicle. Even if the vehicle has no active noise reduction component, the car charging device provided in the present invention provides a function of active noise reduction for the vehicle.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A car charging device with a noise reduction function, comprising:
a main body, comprising an insertion portion and a top;
a charging interface, comprising a charging terminal and located on the top;
an input terminal, located at the insertion portion;
a conversion circuit, electrically connected to the input terminal and the charging terminal, wherein the conversion circuit is configured to convert electric power from the input terminal and output the electric power through the charging terminal;
a microphone, located on the top and configured to convert a sound into an input audio;
a loudspeaker, located on the top; and
a noise reduction circuit, configured to generate a noise reduction audio according to the input audio, and drive, by using the noise reduction audio, the loudspeaker to emit a noise reduction sound, wherein the noise reduction audio is an inversion of a regular audio continuing for a preset time in the input audio.

2. The car charging device with a noise reduction function according to claim 1, wherein the main body has an insert axis, the loudspeaker has a sound emitting direction, and an angle between the sound emitting direction and the insert axis is between 15 degrees and 75 degrees.

3. The car charging device with a noise reduction function according to claim 1, wherein the noise reduction circuit generates a noise value according to the input audio and compares the noise value with a preset value, and when the noise value is less than the preset value, the noise reduction circuit does not generate the noise reduction audio.

4. The car charging device with a noise reduction function according to claim 1, wherein the noise reduction circuit generates a noise value according to the input audio and compares the noise value with a preset value; when the noise value is less than the preset value, the noise reduction circuit maintains the noise reduction audio; and when the noise value is greater than or equal to the preset value, the noise reduction circuit adjusts the noise reduction audio.

5. The car charging device with a noise reduction function according to claim 2, wherein the microphone has a sound receiving direction, and the sound receiving direction is opposite to the sound emitting direction of the loudspeaker.

6. The car charging device with a noise reduction function according to claim 1, wherein the main body further comprises a surface cover, and the surface cover is located on the top and covers the loudspeaker.

7. The car charging device with a noise reduction function according to claim 6, wherein the main body further comprises a main housing and a shell, the main housing is located at the insertion portion, the shell is located on the top, one side of the shell is connected to the surface cover, and another side of the shell is connected to the main housing, and wherein the input terminal is disposed on the main housing, and the charging terminal is disposed on the shell.

8. The car charging device with a noise reduction function according to claim 1, wherein the charging terminal is a USB interface.

9. The car charging device with a noise reduction function according to claim 1, wherein the conversion circuit further comprises a light emitting component, a light guiding component, and a drive circuit; the drive circuit is electrically connected to the light emitting component, and the light emitting component is adjacent to the light guiding component; the light guiding component comprises an exposed portion, and the exposed portion is exposed to the top; and when the conversion circuit receives the electric power, the drive circuit drives the light emitting component to emit light, and the light guiding component guides the light to the exposed portion.

10. The car charging device with a noise reduction function according to claim 1, wherein the top comprises a side surface, the charging interface is located on the side surface, and the microphone is located by side of the charging interface.
